(19) United States
(12) Patent Application Publication
(10) Pub. No.: US 2010/0100801 A1
(43) Pub. Date: Apr. 22, 2010

(54) Router / switch configuration automatic generation method

(76) Inventor: Kenneth McNamara, Pittsboro, IN (US)

Correspondence Address: AT& T LEGAL DEPARTMENT - Monka;ATTN: PATENT DOCKETING, ROOM 2A - 207, ONE AT & T WAY, BEDMINSTER, NJ, 07921, US

(21) Appl. No.: 12/288,495

(22) Filed: Oct. 21, 2008

(51) Int. Cl. G06F 15/177; G06F 17/00

(52) U.S. Cl. 715/212; 709/220

(57) ABSTRACT

A method of automating the generation of network element configurations using a single electronic document is disclosed. A plurality of input statements regarding information relating to hardware, operating system, application and locale for each network element in a network are input to the document. A truth table of permitted hardware and operating system combinations is applied to the input statements. The specific sets of input statements are assembled into configuration skeletons, and a listing is generated of all possible configuration statements for specific hardware-operating system combinations.

### FIELD OF THE INVENTION

The present invention relates generally to computer networking, and more particularly, to systems and methods to simplify the generation of a network device configuration by using a single electronic document.

### BACKGROUND OF THE INVENTION

The use of Computing Devices (CDs) and computer networks are an integral part of personal, corporate and government communication. A computer network is a collection of physically distributed sub-networks, such as local area networks (LANs) that transport data between network nodes. A node may be loosely defined as device adapted to send and/or receive data in the computer network. Therefore, a node may be the source of data to be transported, the destination for data being transported or a location through which data may travel on its way from source to destination.

Network topology is the representation and arrangement of network elements, including links and nodes, and the physical and logical interconnections between nodes. A LAN is an example of a network that exhibits both a physical topology and a logical topology. Any given node in a LAN will have one or more physical links to one or more other nodes in the network typically through one or more intermediate nodes, such as routers and switches, thus defining the physical topology. Likewise, the mapping of the flow of data between the nodes in the network determines the logical topology of the network. The physical and logical topologies might be identical in any particular network, but they also may be different.

Network configuration management (NCM) is the process of organizing and maintaining information about all of the individual devices or components coupled to a computer network. When a network needs repair, modification, expansion or upgrading, the network administrator employs network configuration management tools for these tasks. The network configuration management database is typically consulted to determine the best course of action. This database contains the locations and network addresses of all hardware devices, as well as information about the programs, versions and updates installed in network computers.

Network configuration management tools can be vendor-neutral or vendor-specific. Advantages of network configuration management include: streamlining the processes of maintenance, repair, expansion and upgrading; minimizing configuration errors; minimizing downtime, optimizing network security; ensuring that changes made to a device or system do not adversely affect other devices or systems; rolling back changes to a previous configuration if results are unsatisfactory; and archiving the details of all network configuration changes.

Network elements, such as switches and routers, require complex configuration before they can be placed into service on a network. Correct configuration results in a correctly operating network with minimal downtime and a high level of network availability. Improper configuration can result in complete failure of the device, security holes, and/or outright damage to the network.

Network device configuration consists of an order sensitive list of specific commands. This list of commands ranges in size from 100 to 1,400 lines. In each case a finished configuration combines a hardware environment, specific operating system, application(s) and locale specific parameters (HW-OS-AP*-LOC).

To try and avoid potential configuration problems, configuration standards are laid out by network experts and then communicated to implementers. Sometimes this results in multiple documents for each hardware/application combination. Sometimes a single document is used with multiple “in this case do this” comments and explanations. Although these kinds of documents provide specific information about what is essentially a computer program, none of them can be interpreted or implemented by a computer.

Under current practice it is up to the implementer to combine, interpret and collate the standards and designs from a variety of sources to create a finished configuration. A simple configuration typically has 30 elements which must be determined and inserted at specific locations in the configuration by the implementer. After the configuration is assembled there is no “spelling checker” to detect errors so the implementer depends on “stare and compare”. Manual creation and error checking are both time consuming and error prone processes.

It would therefore be desirable to provide a methodology that employs a single document for collecting human input regarding network configuration decisions, which subsequently, and without modification, may be directly submitted to the computer which is generating a network device configuration. To the inventors' knowledge, no such system or method currently exists.

### SUMMARY OF THE INVENTION

In accordance with a first aspect of the present invention, there is provided a method of automating the generation of network element configurations. The method generally comprises the steps of: receiving, on a single electronic document (i.e., a spreadsheet), a plurality of input statements regarding information relating to hardware, operating system, application and locale for each network element in a network; applying a truth table of permitted hardware and operating system combinations to the input statements; assembling specific sets of statements into configuration skeletons; and listing all possible configuration statements for specific hardware-operating system combinations.

The data residing in the configuration skeletons may then be captured, translated into configuration commands, and communicated to the network elements.

In accordance with another aspect of the invention, there is provided a computer-usable medium having computer readable instructions stored thereon for execution by a processor to enable a computer to: receive, on a single electronic document, a plurality of input statements regarding information relating to hardware, operating system, application and locale for each network element in a network; apply a truth table of permitted hardware and operating system combinations to the input statements; and assemble specific sets of statements into configuration skeletons.

These aspects of the invention and further advantages thereof will become apparent to those skilled in the art as the present invention is described with particular reference to the accompanying drawings.

### BRIEF DESCRIPTION OF THE DRAWINGS

FIG. 1 is a functional block diagram of a prior art communications network;

FIG. 2 is the first portion of an exemplary program/spreadsheet in accordance with an aspect of the present invention;

FIG. 3 is the second portion of the exemplary program/spreadsheet of FIG. 2;

FIG. 4 is the input field list in accordance with an aspect of the present invention;

FIG. 5 is a configuration skeleton in accordance with an aspect of the present invention;

FIG. 6 is an exemplary method in accordance with an aspect of the current invention;

FIG. 7 is an exemplary computing device for implementing the present invention; and

FIG. 8 is an exemplary network access device communicating with a network for implementing the present invention.

### DETAILED DESCRIPTION OF THE INVENTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein are meant to encompass the items listed thereafter and equivalents thereof as well as additional items.

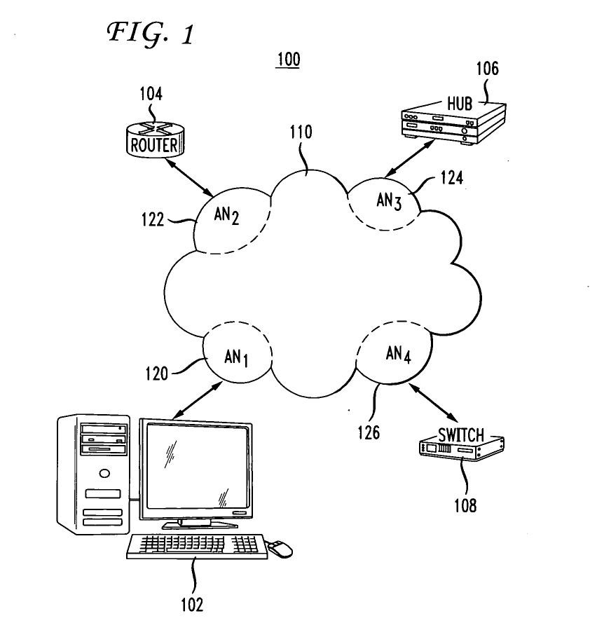

FIG. 1 is a functional block diagram of a prior art communications network 100. In network 100, each network device is coupled to a respective access network (AN) to reach a long-haul network. Specifically, computer 102, router 104, hub 106 and switch 108 are coupled respectively through AN₁ 120, AN₂ 122, AN₃ 124 and AN₄ 126 to reach network 110. Computer 102 of FIG. 1 is configured to provide network configuration management services, such as additions, deletions, changes or other configuration changes and an access point to the network 100 for implementing network configuration changes.

As a network is built, device by device, network configuration including hardware, operating system, applications, locale, and others, must be established and maintained. Examples of network devices may include bridges, routers, workstations, servers, switches and others.

Networks are by nature in a constant state of flux. Any of the engineers responsible for the implementation and maintenance of the network can change the configuration of the devices, such as switches and routers, at any time. When configuration changes to live equipment, those that are actively participating in network function and operations, is done improperly, it can have devastating effects on the reliability of the network and the services provided by it.

There are direct correlations between properly configured devices and network security. Whether configuration changes are introduced through malicious attacks, manual update errors, or network product defects, devices having access to the network can become vulnerable and place the network at risk.

The present invention reduces the configuration documentation to a single document which can be maintained manually by multiple experts, then on demand, be interpreted and implemented by a computer program. The exact finished configuration is built dependent on specific input variables and automatically combines essential HW-OS-AP*-LOC (hardware, operating system, application(s), locale) information.

By the combination of program logic and a list of all the possible configuration statements for a specific HW/OS environment) in one place, network configuration can be condensed to a single document.

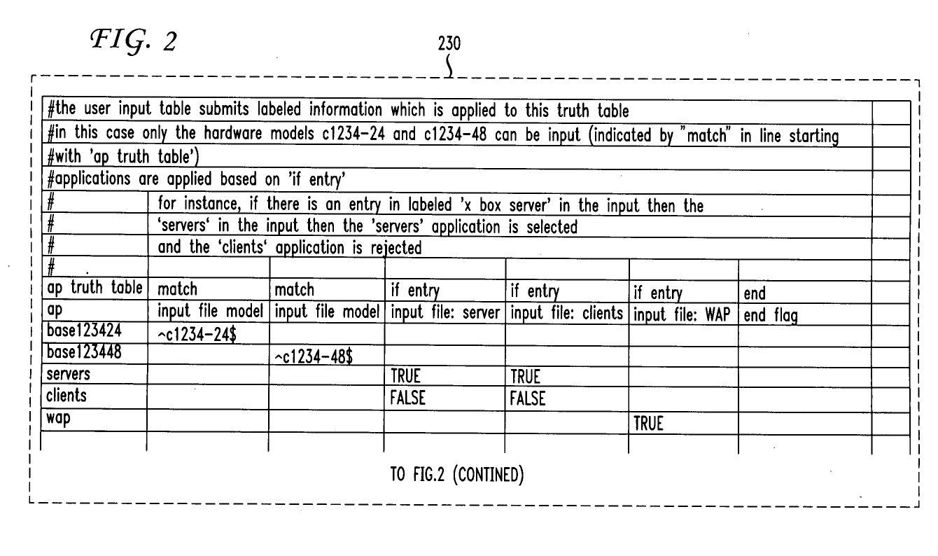

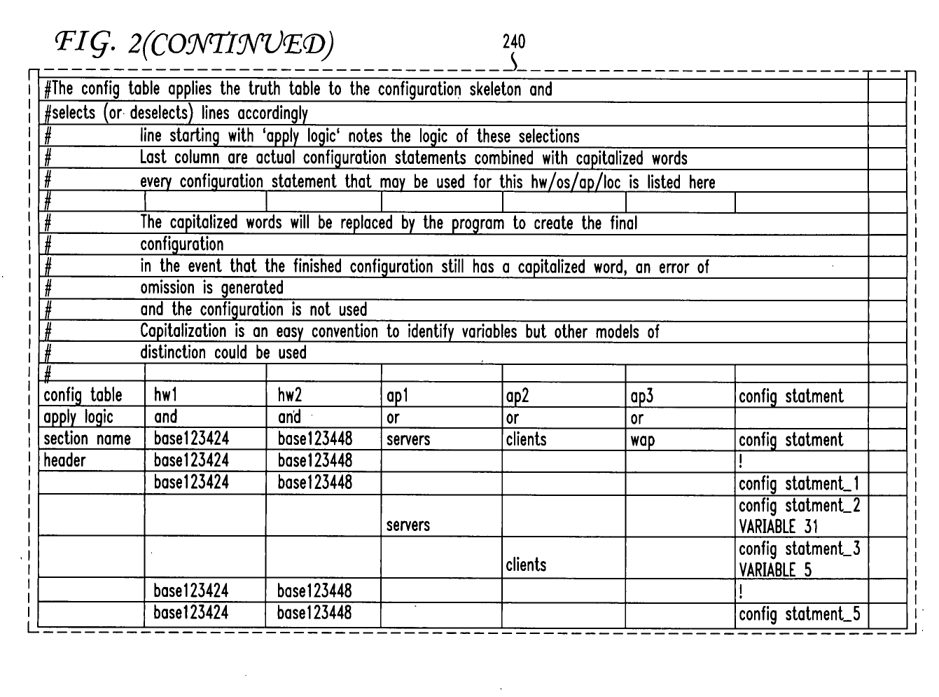

Referring now to FIG. 2, an exemplary program/spreadsheet of the present invention. This program/spreadsheet includes the logic for device configuration, and the configuration generator which assembles specific sets of statements into configuration skeletons and inserts locale information to finish them. The skeleton is created based on specific logical conditions which will allow the network to function properly. When the logical conditions are met, the configuration will be allowed into the skeleton, and likewise when the logical conditions are not met, the configuration will not be allowed into the skeleton. An example of a condition not being met could be when a locale variable is missing or corrupt. If the logic requires particular values to be present in a particular field of the configuration and this condition is not met, this “bad” configuration setting is not included in the configuration skeleton and an error message is generated. Only when all the configuration settings pass through the “truth tables”, essentially for validation, are they allowed to become part of the configuration skeleton and then be uploaded to the network to become part of the live network configuration. By preventing “bad” configuration settings to be created, and introduced to the network, the network problems discussed earlier can be avoided.

FIG. 2 contains the first portion of an exemplary single document 200 of the present invention which to generate configurations for a network comprised of 2 Internet Protocol (IP) switches (e.g., Cisco Catalyst 123424 and 123448) and any of 3 possible applications (e.g., ap1-‘servers’, ap2-‘clients’, ap3-‘wap’). An IP switch, as known by those skilled in the art, is basically an IP (Internet Protocol) router with a switching hardware that has the ability to cache routing decisions. An IP switching device identifies a long flow of packets and switches the flow in layer 2 or data link layer of the 7 layer Open System Interconnection (OSI) networking model.

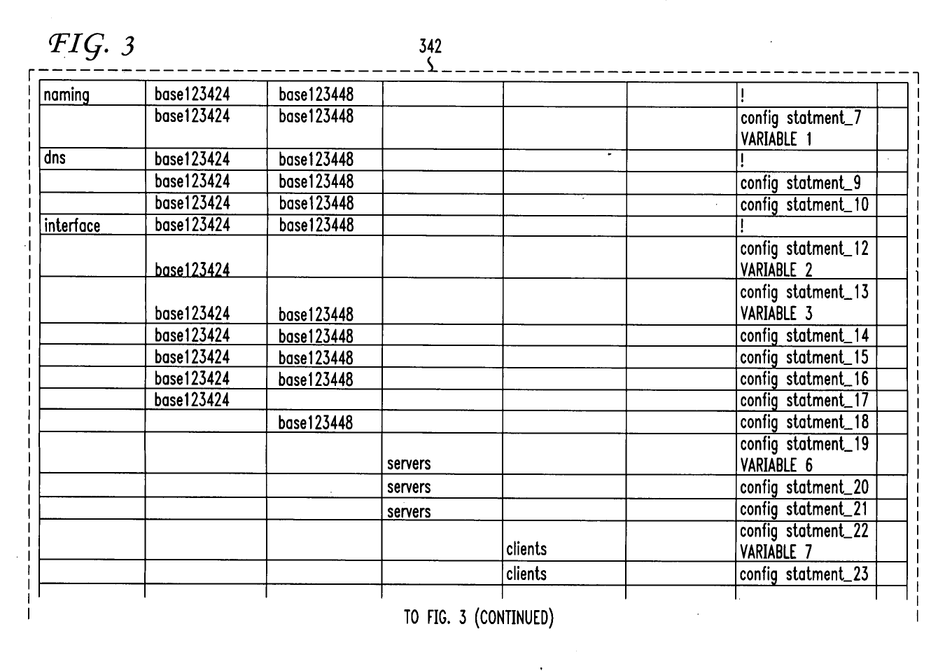

FIG. 3 contains the second portion of the exemplary single document of the present invention.

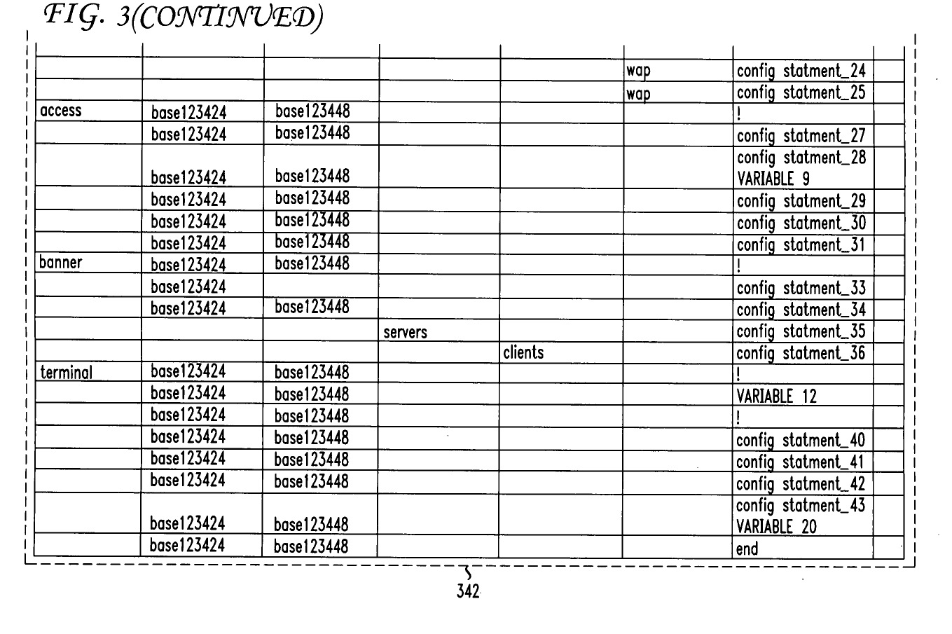

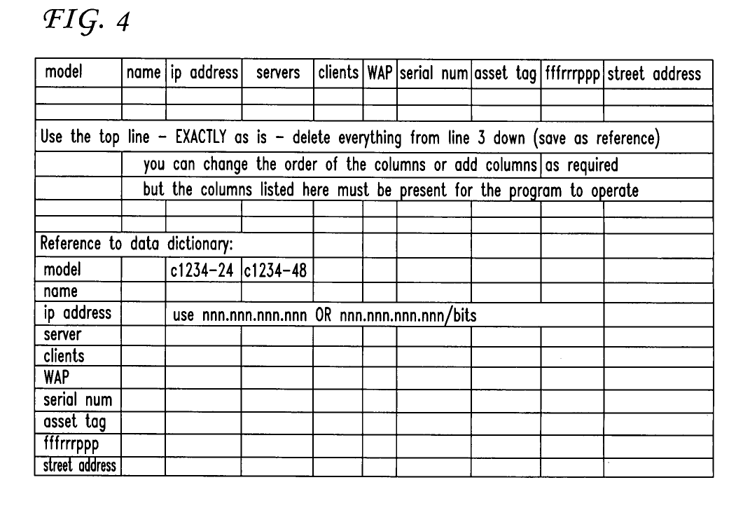

FIG. 4 shows the specific input files for matching entries of the present invention.

Referring back to FIG. 2, the “truth table” 230, shows the allowed HW+AP* combinations of the exemplary network. The program/spreadsheet of FIG. 2 tests specific input fields of FIG. 4, for “matching” entries, and the existence or absence of any input, or default entries.

A specific combination of inputs compared to the truth table 230 of FIG. 2 might result in a configuration for hardware device BASE123424: HW-“BASE123424”, AP1-“servers”, AP2-“clients”, AP3-“wap” configuration. Section 240 of FIG. 2 and section 342 of FIG. 3 contains columns with these entries. It is the presence or absence of an entry in the respective column that selects or rejects a specific line of the configuration to be added to the “configuration skeleton”.

In the next to last column of the section 240 of FIG. 2 and section 342 of FIG. 3, labeled “config statement”, is a list of all the possible configuration statements for specific HW-OS combinations. The HW and AP columns are used to select or delete (by AND'ing) specific lines or named sections from the “config statement”.

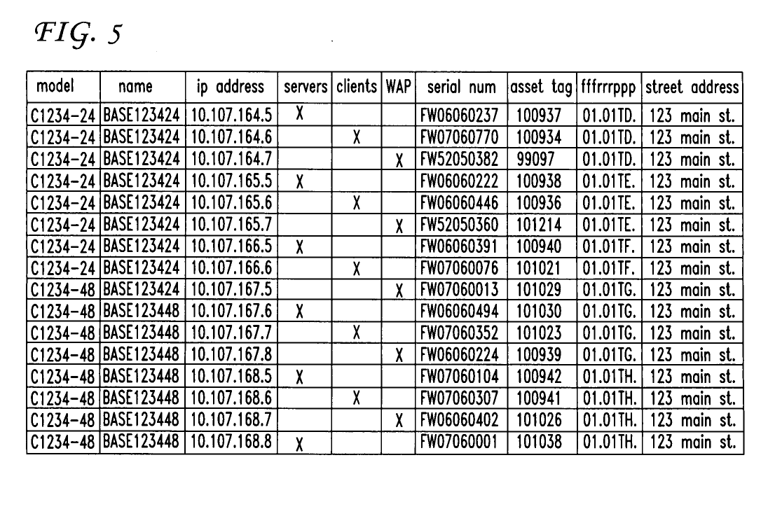

FIG. 5 is an illustration of an illustrative output of a “configuration skeleton”. After the insertion of LOC (locale) information is done by substituting the data calculated from the input or indexed elsewhere for the CAPITALIZED words, the “configuration skeleton” is complete, and ready for insertion into the live network configuration.

By putting all the configuration statements (and just the configuration statements) in one column of FIG. 4, the network engineer and the network implementer have a single place to document, explain, and discuss configuration requirements for any given HW-OS-AP*-LOC combination.

Finally, since the spreadsheet/program of FIGS. 2 and 3 selects a specific “HW-OS-AP*-LOC” combination, it is possible to detect errors of omission in FIG. 5 since it is expected that ALL the capitalized words in the generated configuration will be filled in. When one is not, an error is detected.

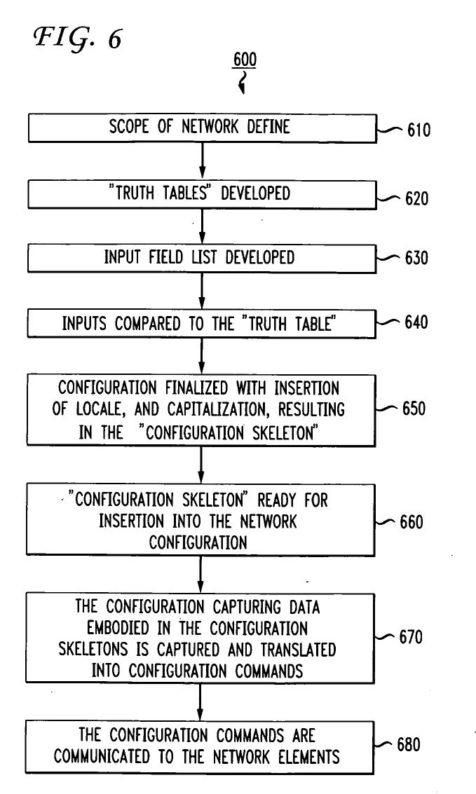

FIG. 6 is a flow diagram of an exemplary method 600 in accordance with an aspect of the present invention. In step 610, the scope of the network to be implemented is determined. This may include the hardware, operating system, applications, locale and other characteristics.

In step 620, “Truth Table(s)” is/are developed for the network. These comprise the logic to be used to test inputs (devices, operating systems, applications, locales and the like), to known compatibility standards for interoperability.

In step 630, the Input field list is developed. This is the list to be used for “matching” entries, existence or absence of any input, or default entries with the truth table(s).

In step 640, a plurality of input statements regarding information relating to hardware, operating system, application and locale for each network element in the network are received and combinations of inputs are compared to the truth table, resulting in hardware—operating system—application configurations.

In step 650, the configuration is finalized by the addition of the locale information and all fields CAPITALIZED, resulting in a “configuration skeleton”. It will be appreciated by those skilled in the art that capitalization is one way of identifying particular variables. Other methods for distinguishing such variables can be employed, such as underlining, font changes and the like.

In step 660, the “configuration skeleton” is ready for insertion into the live network configuration.

In step 670, the configuration capturing data embodied in the configuration skeletons is captured and translated into configuration commands.

In step 680, the configuration commands are then communicated to the network elements.

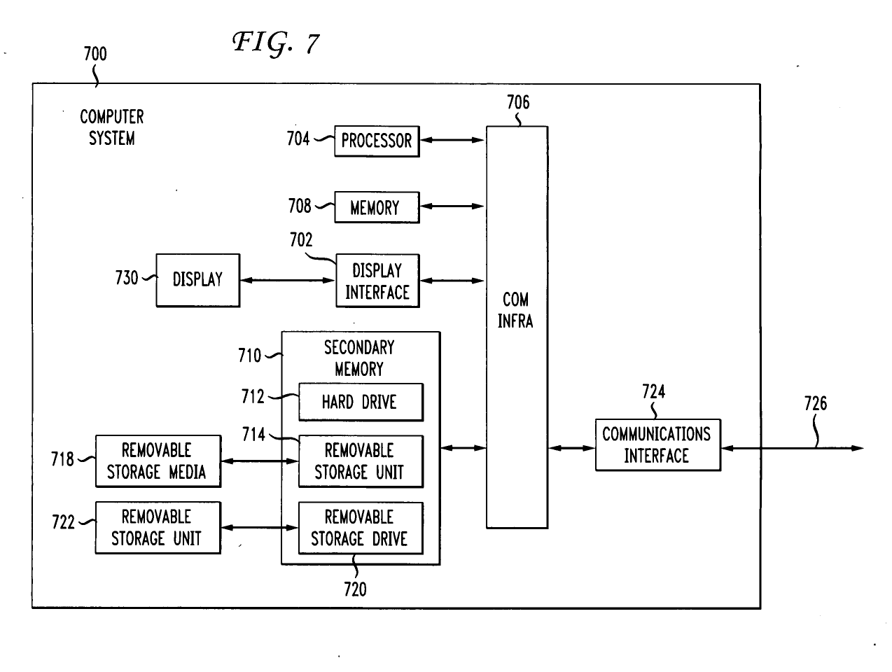

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 700 is shown in FIG. 7. Computer system 700 includes one or more processors, such as processor 704. Processor 704 is connected to a communication infrastructure 706 (e.g., a communications bus, cross-over bar, or network). Computer system 700 can include a display interface 702 (e.g. a graphics card) that allows graphics, text, and other data from the communication infrastructure 706 (or from a frame buffer not shown) to be displayed on a display unit 730. Computer system 700 also includes a main memory 708, preferably random access memory (RAM), and may also include a secondary memory 710. The secondary memory 710 may include, for example, a hard disk drive 712 and/or a removable storage drive 714. The removable storage drive 714 has read/write functionality onto removable storage media 718 having stored therein computer software and/or data. In alternative embodiments, secondary memory 710 may include other similar devices for allowing computer programs or other instructions to be loaded into computer system 700. Such devices may include, for example, a removable storage unit 722 and an interface 720. Examples of such may include a program cartridge and cartridge interface (such as that found in video game devices), a removable memory chip (such as an erasable programmable read only memory (EPROM), or programmable read only memory (PROM)) and associated socket, and other removable storage units 722 and interfaces 720, which allow software and data to be transferred from the removable storage unit 722 to computer system 700. Computer system 700 may also include a communications interface 724 allowing software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals (not shown), which may be electronic, electromagnetic, optical or other signals capable of being received by communications interface 724. These signals are provided to communications interface 724 via a communications path (e.g., channel) 726. This path 726 carries the signals and may be implemented using wire or cable, fiber optics, a telephone line, a cellular link, a radio frequency (RF) link and/or other communications channels. Computer programs (also referred to as computer control logic) are stored in main memory 708 and/or secondary memory 710. Computer programs may also be received via communications interface 724. Computer programs, when executed, enable the computer system 700 to perform the features of the present invention, as discussed herein. Accordingly, such computer programs represent controllers of the computer system 700. In an embodiment where the invention is implemented using software, the software may be stored in a computer program product and loaded into computer system 700 using removable storage drive 714, hard drive 712, or communications interface 724. The control logic (software), when executed by the processor 704, causes the processor 704 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s). In one exemplary embodiment, the system for the present invention may be implemented, for example, as a Microsoft.net® desktop application program (Microsoft.net® is made by Microsoft® Corporation of Redmond, Wash.), which may reside on a computer hard drive, database or other repository of data, or be uploaded from the Internet or other network (e.g., from a PC, minicomputer, mainframe computer, microcomputer, telephone device, PDA, or other NAD having a processor and input and/or output capability). Any available software tool capable of implementing the concepts described herein may be used to implement the system and method of the present invention. The method and system of the present invention may also be implemented as an application-specific add-on to a program, or as a standalone application.

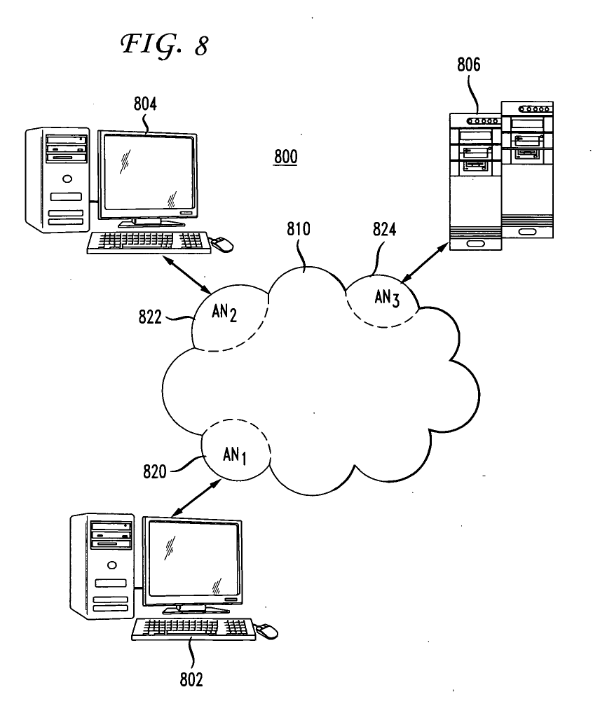

Referring to FIG. 8, data for use in the system is, for example, input by one or more Network Access Devices (NADs) such as NAD 802 and NAD 804, among a plurality of NADs via, for example, a network 810, such as the Internet or an intranet, and access networks (ANs) AN₁ 820, AN₂ 822 and AN₁ 824. The ANs may include, for example, wired, wireless, or fiberoptic links. Examples of such NADs include a personal computer, laptop computer, minicomputer, mainframe computer, microcomputer, telephonic device, or wireless device, such as a hand-held wireless device. These NADs communicate over the communications network 810 to a server 806 (or network of server computers) that implements the functionality above. Server 806 may also be considered to be a NAD, having a processor and a repository for data and/or connection to a processor and/or repository for data.

The implementation of the above described method could have the following benefits: time savings, reduction in network problems, and time saved specifying and implementing standards.

Time savings: Time saved creating configurations by implementers over manually collecting and collating requirements may be around 30%.

Reduction in network problems: Misconfiguration can be costly to network performance, reliability, security and maintenance costs. A misconfigured router or switch can fail in a number of ways. Frequently, configuration errors require several people, considerable time and often a site visit to resolve.

Time saved specifying and implementing standards: By designating a single document which can be read and modified by human beings, and then input directly into the computer to generate configurations, it is possible to provide a known point in the process for direct and precise control of configurations by network experts. As a result, network implementers will have fewer questions about standards, thereby reducing the time to implement.

The inventive method is extensible, in that it may be extended to generate configurations for any hardware/operating system/application manufacturer.

This method makes it easy to change (modify, add or delete) configurations that are generated, and reduces the costs and time associated with program maintenance and modification.

The foregoing detailed description is to be understood as being in every respect illustrative and exemplary, but not restrictive, and the scope of the invention disclosed herein is not to be determined from the description of the invention, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

I claim:

1. A method of automating the generation of network element configurations, comprising the steps of:
receiving, on a single electronic document, a plurality of input statements regarding information relating to hardware, operating system, and application for each network element in a network;
applying a truth table of permitted hardware and operating system combinations to the input statements; and
assembling specific sets of statements into configuration skeletons.

2. The method recited in claim 1, further comprising the step of receiving locale information for the network elements.

3. The method recited in claim 1, further comprising the step of listing all possible configuration statements for specific hardware-operating system combinations.

4. The method recited in claim 1, further comprising the steps of capturing data embodied in the configuration skeletons, translating the data into configuration commands, and communicating the configurations to the network elements.

5. The method recited in claim 1, further comprising the step of making the single electronic document available for viewing on a plurality of networked devices via a graphical user interface.

6. The method recited in claim 1, wherein the single electronic document is a spreadsheet.

7. A method of automating the generation of network element configurations, comprising the steps of:
receiving, on a single electronic document, a plurality of input statements regarding information relating to hardware, operating system, application and locale for each network element in a network;
applying a truth table of permitted hardware and operating system combinations to the input statements;
assembling specific sets of statements into configuration skeletons; and
listing all possible configuration statements for specific hardware-operating system combinations.

8. The method recited in claim 7, further comprising the steps of capturing data embodied in the configuration skeletons, translating the data into configuration commands, and communicating the configurations to the network elements.

9. The method recited in claim 7, further comprising the step of making the single electronic document available for viewing on a plurality of networked devices via a graphical user interface.

10. The method recited in claim 7, wherein the single electronic document is a spreadsheet.

11. A computer-usable medium having computer readable instructions stored thereon for execution by a processor to enable a computer to:
receive, on a single electronic document, a plurality of input statements regarding information relating to hardware, operating system, and application for each network element in a network;
apply a truth table of permitted hardware and operating system combinations to the input statements; and
assemble specific sets of statements into configuration skeletons.

12. The computer-usable medium of claim 11, having computer readable instructions stored thereon for execution by a processor to further enable the computer to receive locale information for the network elements.

13. The computer-usable medium of claim 11, having computer readable instructions stored thereon for execution by a processor to further enable the computer to list all possible configuration statements for specific hardware-operating system combinations.

14. The computer-usable medium of claim 11, having computer readable instructions stored thereon for execution by a processor to further enable the computer to capture data embodied in the configuration skeletons, translate the data into configuration commands, and communicate the configurations to the network elements.

15. The computer-usable medium of claim 11, wherein the single electronic document is a spreadsheet.
